(19) United States
(12) Patent Application Publication
(10) Pub. No.: US 2011/0093879 A1
(43) Pub. Date: Apr. 21, 2011

(54) Banking video frames associated with links and processing the banked frames

(76) Inventors: Carole T. Salkind, Rockaway, NJ (US); William J. Fulco, Santa Monica, CA (US); Michael S. Shipp, Marina del Rey, CA (US)

(21) Appl. No.: 10/664,350

(22) Filed: Sep. 16, 2003

(51) Int. Cl. H04N 7/16; H04N 5/445

(52) U.S. Cl. 725/23; 725/41

(57) ABSTRACT

A method of banking video frames associated with links, includes the steps of associating multiple links with a video frame in a series of video frames, each of the links having information associated therewith, selecting and banking the video frame from among the series of video frames; and selecting and displaying the frame in connection with representations of the links. The method may further include a step of selecting one of the links and displaying the information associated therewith. In one embodiment, the links may be lead ins for an advertisement such as a telescoping advertisement, they may be purchase opportunities, the may be opportunities for coupons, or other interactive activities. An apparatus for performing the method includes a set top box with memory, a processor, and a digital converter for converting digital video images into suitable picture images. The apparatus stores the selected frame either locally or at a network or head-end. Banking frames can be done with a standard remote control using the up, down, left and right arrow keys to navigate the screen, and the select or enter key to perform the storage function, or by adding a key or keys, such as “bank”, “click” or “store” to perform the storage function.

### BACKGROUND OF THE INVENTION

The present invention relates to banking video frames with links ad processing thereof in real time and in time deferred situations.

Recently, television has been enhanced by the development of digital television which may be digitally processed at a TV set top box having digital storage such as via a hard drive, and thereby PVR (personal video recording), DVR (digital video recording) and/or VOD (video on demand). These enhancements generally have in common that a hard drive, i.e., storage for digital information, is available either in a set top box essentially like a cable box usually placed on top of the TV (but it could be incorporated in the TV) or located at the video provider or otherwise remotely located. The hard drive stores the television/movie video signals. In a case of VOD, this is done at the VOD provider or the VOD provider's server.

In digital television such as provided under the brand name TiVo™, the television broadcast is digitized and sent to the set top box, or digitized within the set top box (as is the case with TiVo™ at the viewer's location, e.g., his or her home. The box contains a hard drive. Programs may be stored on the hard drive at the viewer's home and replayed later. This is similar to using a VCR, but has much more flexibility in that video tapes are not necessary and that any particular show can be recorded if the viewer's TV or tuning device has been tuned to that channel in as much as the show signal can be stored in a streaming buffer or streaming area of the hard drive in case the user decides to record it. The streaming buffer, for example, may store one hour's worth of video.

In the case of digital cable without the PVR function, or even in the case of VOD, a viewer has a box which typically does not have any significant storage. There is a processor memory and video converter, but the memory mainly carries guide information, product information, and perhaps other general information along with the processor control programming.

Generally speaking, it has been proposed to embed in video signals hotspots in each frame. The storage of these hotspots enables a link or links to be invoked to other data. It has also been proposed to click on an area in a frame and store information related to the area. However, if there are multiple hotspots in a frame, there is no way to store the data without destroying or hampering a continuous viewing process. The viewer would have to quickly and madly move the mouse or cursor or selector over the video frame while the video is moving, and make rapid decisions on what to store. Alternatively, the user would have to interrupt the flow of the show by pressing the pause button and then moving the mouse around, clicking on everything.

The present invention stores the frame data and thus stores or enables capture of all of the hotspots associated with the frame for later viewing. The viewer need not make a significant selection while watching the video. Accordingly, the viewer need not be bogged down or distracted in the logistics which would interrupt the flow of the program or movie being watched.

### SUMMARY OF THE INVENTION

In one embodiment, the present invention provides a viewer of television or other video, such as in the case of video provided in association with or by PVR (sometimes known as DVR), DVD or VOD, with an opportunity to bank (store) video frames of interest, and the viewer can then view various links to further information or purchases, coupons or other interactions. This information preferably includes links that are embedded in the video frame, either carried with the video signal, or separately, and either synchronously (in real time) or asynchronously (sent or obtained later), e.g., upon calling up any banked frames. The linking data, which preferably includes multiple items in the video frame, can be matched up with the frame by frame number data or other frame identifier. It can identify an item or items in the video frame by position data, such as an X,Y position or positions of the periphery of items or areas of interest in the video frame. Such items may include, e.g., an actor's shirt or other goods, an actor, a geographic location shown in the scene/frame, or other area or item of interest shown in the video frame.

Upon viewing of the banked frame, whether in real time (immediately upon selecting the frame) or time delayed (after watching more of a movie, TV program, etc.), the links associated with that frame are displayed. Additional links may also be displayed, including advertisements, sponsorships or other marketing or promotional material or informational or other links, which are associated with that frame, or which are associated with the whole program or movie, such as a sponsor advertisement.

In a preferred embodiment, the present invention enables advertisers to provide the viewer with an opportunity to view advertising and act on it, either immediately or after calling up a banked frame, even if the advertising was skipped by the viewer before, e.g., the viewer recorded the program and skipped watching the commercials. The advertising may also be advertising that is only available through frame banking, i.e., it is only associated with the displayed banked frame, and is not part of the movie or TV program broadcast. It also enables producers of programs to provide a means of interactivity for further information, related videos or other activity such as coupons or discounts, or commerce opportunities. For example, a user may be watching a video and be intrigued enough to want further information on an actor's clothing. The user may be interested in purchasing the same or similar clothing to that worn by the actor. The user may be interested in obtaining the written transcript of the program. In a news piece, the user may be interested in obtaining more information on an incident. A myriad of possibilities exist. By allowing the user to bank or store a frame and correlating that banked frame with link information, it is possible for the user, upon demand or upon the end of the program or both, to interact without having to memorize or write down information shown or described in the frame. Even if the user is watching advertising, the user can bank a frame of the advertising for future access. The user then need not memorize a phone number, web address, or other information, can pursue all the information associated with a frame, without having to madly “click” all over the frame to try to store any data associated therewith, thus destroying or hampering the viewing experience of the movie or show.

In another preferred embodiment, the viewer when done watching the video or TV program, and may display the banked frames, e.g., with thumbnail pictures on the frame. The user selects the desired thumbnail, which may then show on a larger screen, preferably on the same display but it need not be. The display also preferably may in words and/or in icons or thumbnails, show the active areas of the frame. The active areas may be encoded in the video stream directly or by separately stored information, linked by frame number, such as in U.S. patent application Ser. No. 10/443,301, filed May 21, 2003, and commonly owned, incorporated by reference herein. Therefore, if one were to bank a frame in a TV show in cooking, one may be able to buy the exact pan that the chef in the show is using. Clicking on the link may then take the viewer to a web page where the pan can be purchased. Alternatively, or in addition thereto, it could show the viewer advertising and give the viewer an opportunity to obtain a coupon credit. The credit could be electronically sent to a store's database for later access when the viewer arrives at the store or when the viewer purchases via the World Wide Web or otherwise.

Here, a viewer's frame, item or link selection could be stored and sent, e.g., via modem at a desired interval or present interval, e.g., once per week at two (2) a.m., or otherwise. In the case of VOD, PVR and digital television, there already exits some capability for the viewer to communicate in real time with the provider. For example, in VOD, the video is sent in real time to the viewer's set top box located near the TV. The user selection of a video is sent in real time to the VOD provider. These existing channels of communication may be used or other channels may be used.

Additional embodiments of the invention may include links for the viewer to obtain a coupon, either to be mailed to the viewer, or electronically credited to the viewer's account at a specified store or business, links leading into a telescoping information presentation, and/or e.g., links to purchase.

A viewer may also choose to electronically send any or all of the banked frames or links to another device such as a computer or PDA. This action may take the chosen frames and links and store them in an email account of the viewers for display and processing at a later time.

### BRIEF DESCRIPTION OF THE DRAWINGS

FIGS. 1, 2 and 3 are schematic views for purposes of showing and describing a flow of operations of a system in accordance with a first embodiment of the invention for banking video frames and providing associated links;

FIGS. 4, 5, 6, 7 and 10 are partial schematic views of a display on a television or monitor for purposes of explaining the first embodiment of the invention;

FIG. 8 is a schematic view of a television or monitor, a set top box, a remote control, and a digital television and/or video provider in addition to a third party system for purposes of explaining information flow between such devices and systems;

FIG. 9 is a chart of linking data (metadata) to be accessed as desired by a viewer of a video marked in accordance with one embodiment of the invention, to link secondary data to video program (primary) data in association with a corresponding video frame; and

FIGS. 11, 12 and 13 are flowcharts of various steps in the video banking system of a preferred embodiment of the invention.

### DESCRIPTION OF THE PREFERRED EMBODIMENT(S)

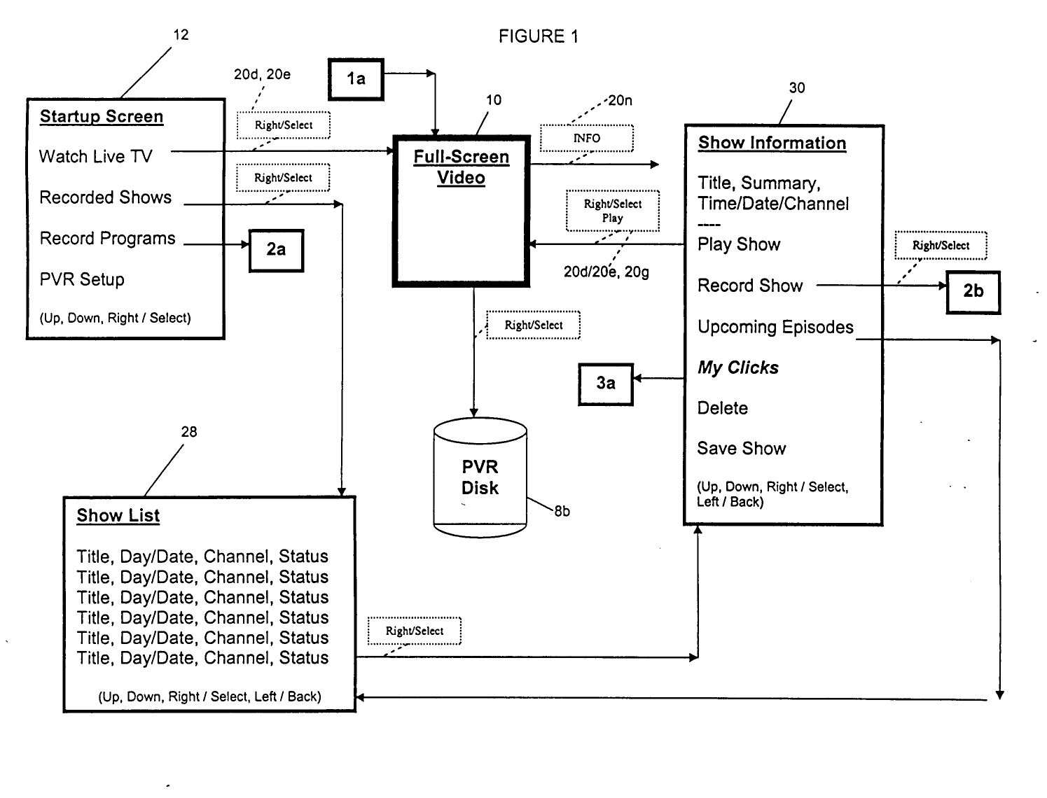

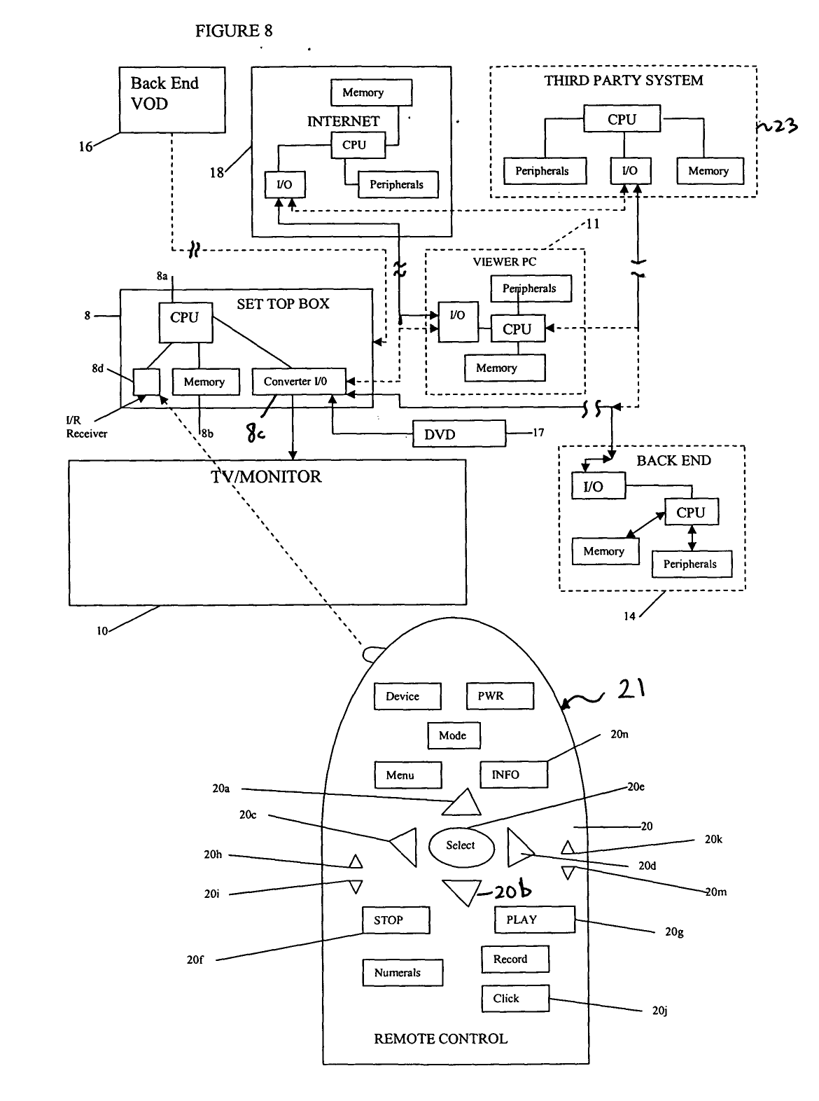

FIG. 1 is a schematic diagram of various screen menus for purposes of explaining typical PVR/DVR and FIG. 8 is a schematic view of hardware and devices for use. Element 8 (FIG. 8) represents a “set top box” which is located at a user's or viewer's location, usually atop a TV/monitor 10. The set top box 8 normally, in the case of current PVR, has a controller or CPU 8a for performing the control functions, a memory 8b (which may include a PVR disk), and a converter 8c serving essentially as an input/output (I/0) device to receive video signals from any of various sources, along with any other embedded information, and transmit the video signals to the TV/monitor 10 (or display). The other information may be stored in memory 8b, used by CPU 8a, or also be display signals for TV/monitor 10. Converter 8c may represent multiple devices. Box 8 could be formed as part of TV/monitor 10, or could also be connected to (or formed as part of) a viewer's PC 11.

Memory 8b may in essence be a “hard drive” (with disk storage for PVR or including sectors on the hard drive referred to in the drawings as “disk storage”) for digitally storing recorded shows, controller applications, holding the video signals from a show being viewed in buffer memory, and/or storing guide and/or instructional information on operation of the box.

In a preferred embodiment, turning on the box 8 (typically left on by the user) and display 10 provides a startup screen on display 10 with a menu represented by element 12. A user or “viewer” then selects, typically using a remote control for the video display device, various functions such as: watch live TV, watch recorded shows (which may be recorded from the TV signal from “back end” source 14, a DVD player 17 connected to box 8, or VOD 16 such as provided by a cable, satellite or broadband internet source 18). Basically, video signals may come directly or indirectly, via direct connection to cable, satellite, broadband internet or other source, or from the source via the internet, and/or directly or indirectly through the PC 11, and may be via hard wiring or wireless, to box 8.

The viewer, instead of watching live TV, may watch recorded programs, or may pick programs to record, e.g., via a guide displayed on TV/monitor 10. Typically there are also setup functions such as phone number or numbers for modem connections, setting up satellite antennae, if applicable, time and date, defaults such as default TV or video signal formats, and other well known functions.

Preferably, there is a remote control 20 communicating, e.g., by IR signals, with an FR receiver 8d in box 8. Remote control 20 may need only a few buttons, such as an up arrow 20a, down arrow 20b, left arrow 20c, right arrow 20d, select 20e (enter), stop 20f (which may be pause if hit once and stop if hit twice or separate buttons), play 20g, channel-up 20h, channel-down 20i, and CLICK 20j (which could be performed by the “select” button when the box is playing, as desired). Volume up 20k and volume down 20m also are typical buttons.

Whenever there is a list on the screen, the up arrow (UP) moves the highlight up the list, the down arrow (DOWN) moves the highlight down the list. Pushing either the right arrow (RIGHT) or select button (SELECT) will choose whatever is currently highlighted, which usually then entails moving to a next screen or next status of the current screen. Pressing the left arrow (LEFT) will take the viewer back to the previous screen (or previous status of the screen). This control process is quite similar to navigating on the internet using the forward and back arrow keys of a web browser, and also somewhat like using the up and down keys on a web browser, and enter key (when the user does not use the mouse).

Options from the Startup Screen

With watch live TV highlighted, pressing RIGHT or SELECT changes the screen to TV mode and sets the PVR to watching the current channel. The channel up and channel down keys 20h, 20i work to change channels as is conventional.

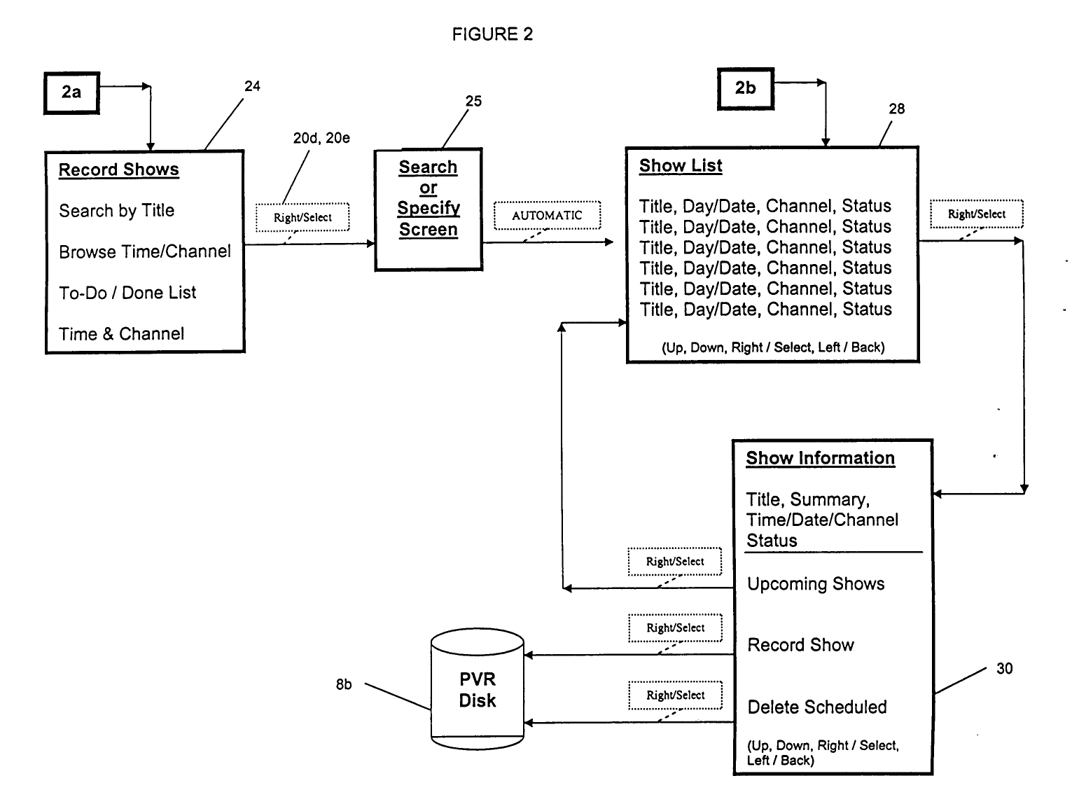

With the record programs entry highlighted, pressing RIGHT or SELECT takes the viewer to the recording show screen 24 via path 2a, as shown in FIG. 2.

Another option from startup screen 12 is with PVR setup highlighted, the viewer is taken to the page that does global setup for the device.

From the startup screen 12, when watch recorded shows is highlighted, the PVR changes to screen 28 to display a list of currently stored (on the hard drive, though it could include cable-head-end VOD selections, or other delivery and/or storage media). This list of shows is scrollable via the UP or DOWN buttons. Selecting a show using RIGHT or SELECT will change the PVR to a show information screen 30. From the show information screen, which may also be accessed by pressing INFO button 20n while watching TV (pre-recorded or live). The viewer can display information and manage options relating to this show (either recorded on the hard drive or the current live TV show).

### From the Show Information Screen

While on the show information screen 30, current information on the program being played is displayed at the top, such as title, synopsis, date, time, length, channel, status, My Clicks (if any)(to bank frames, as discussed further below), etc. This screen provides and displays information about the show that is playing on TV or, if pointing toward the hard drive or other source, the show from that source.

Selecting the play show option (RIGHT or SELECT) or, pressing the play button, takes the viewer (back) to playing the selected show. As noted above, the show may be TV, recorded on disk, or from another source. Whatever the case, due to the use of the buffer, the show is preferably played from the disk/hard drive 8b.

Selecting record show or pressing the record button starts the recording process immediately (if this show information screen is about the current TV program. Alternatively, if this screen has been accessed from a list of future shows, selecting record will put the show's information into the To-Do list for execution later.

Selecting upcoming shows (or upcoming episodes) or pressing the INFO button 20n, brings up (another) show list screen that displays all occurrences of this show in the future. At this point, the viewer can select any of those items to bring up a show information screen for that particular show and set the box's CPU to record it when it airs.

Selecting delete or pressing the clear button brings up a conformation dialog screen (not shown) and if answered in the affirmative, the show is deleted from the disk. Delete may also be used to cancel a scheduled future recording for the show.

If save show is selected, the CPU asks for how long. The viewer may then select the time frame, up to permanent, for which the show will remain stored in memory.

Accessing Banked Frames

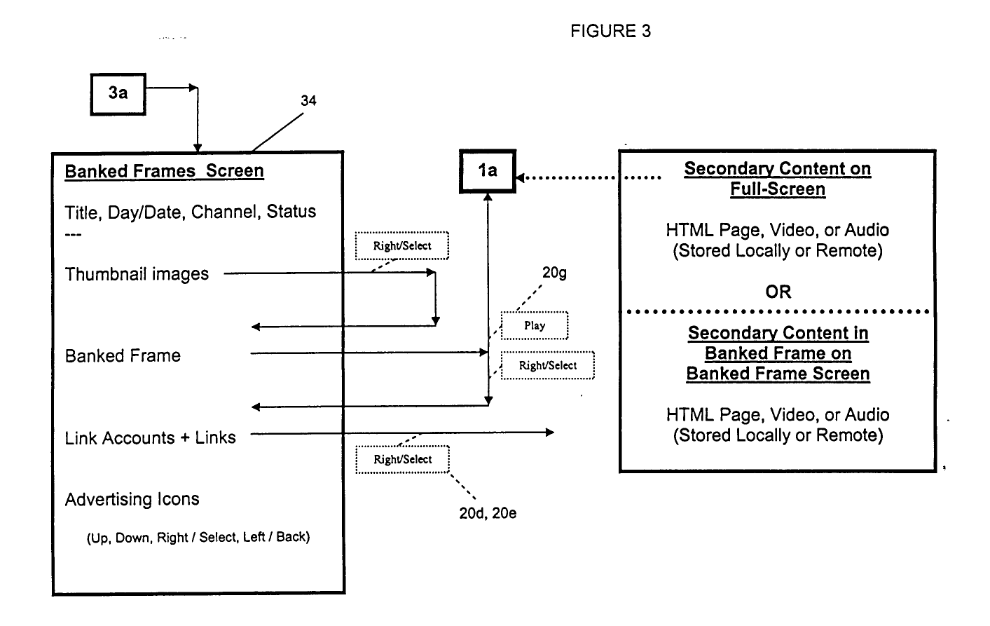

Selecting my clicks brings up any stored (banked) clicks on a banked frames screen 34 via path 3a, as shown in FIG. 3. The viewer can now manage and/or navigate the banked frames. As frames are banked, preferably the location/time of the frame in the show (movie, program, etc.) is stored with the show information on the PVR drive. In the case of live TV, these banked frames are also stored. Optionally, it would also be possible to bank a frame or frames and just store that frame or those frames, even if the remainder of the video is not stored.

Recording Dialogs and Screens

There are two entry points into the recording dialogs from the rest of the system. The first is via the record shows screen 24. This serves as a master record page. That is, the menu the viewer navigates to when he/she decides to record a show and wants flexibility to use several ways (title, time, to do etc) to locate the desired show to record. Thus, the viewer follows path 2a and uses search screen 25, as shown in FIG. 2. The other way the viewer may reach this recording screen 24 is by pressing, “record” or selecting record show from the show information screen 30 of an already known show (including live TV), arriving via path 2b at show screen 28 and then selecting the desired show on screen 28, thus passing to show information screen 30 and selecting record show.

With regard to the search for a show option, as shown in FIG. 2, on the record shows screen 24, each selection, Search by Time, Browse Time/Channel, To-Do/Done List and Record by Time/Channel will lead to search screen 25 where desired parameters may be input and the CPU performs “the search”. The search result is the standard show list screen 28. Selecting any of these (future) shows brings up the show information screen on them with the same above functionality.

Another entry point is directly to the show list screen 28 by specifying a show using the prior screen (as shown by path 2b).

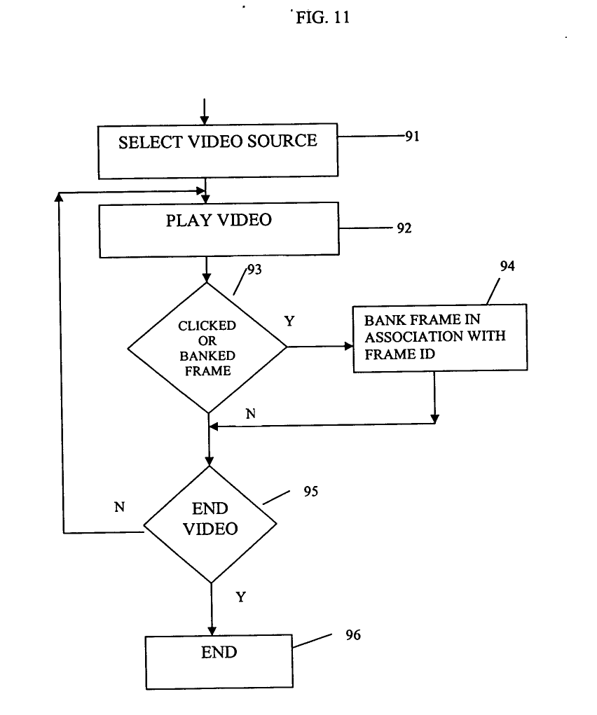

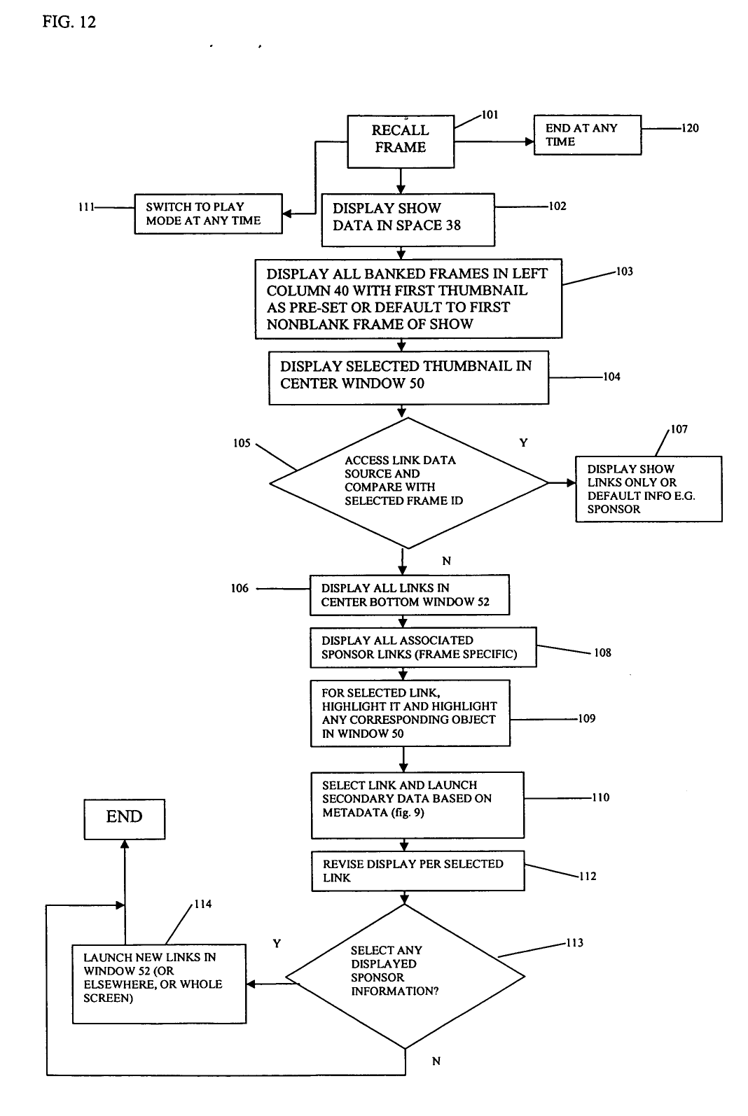

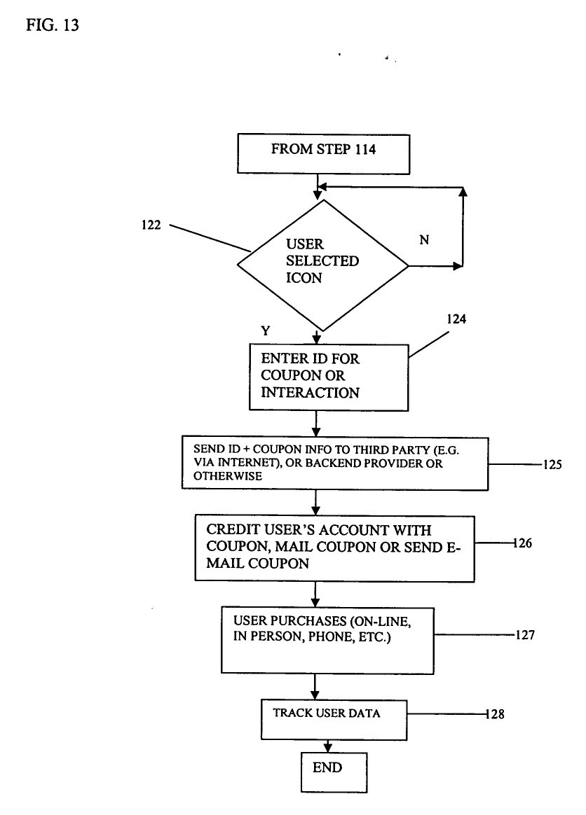

As shown in FIG. 11, watching video, from any selected source (step 91), the user plays the video (step 92). Whenever there is a frame of interest, the user banks it (steps 93 and 94). The frame and its location data (time code or ID) are stored. The user can continue watching until he or she decides to end (steps 95-96).

The Banked Frames Screen

The Banked Frame screen is divided into functional areas, e.g., five areas that include:

1) The show information/status area (which optionally may have a line at the top of the screen).

2) The List of banked frames, preferably displayed as thumbnail images of the selected/banked frame.

3) The banked frame for the currently selected Thumbnail image.

4) The List of “accounts” and “links” for the banked frames.

5) The Sponsor Icon/Logo area.

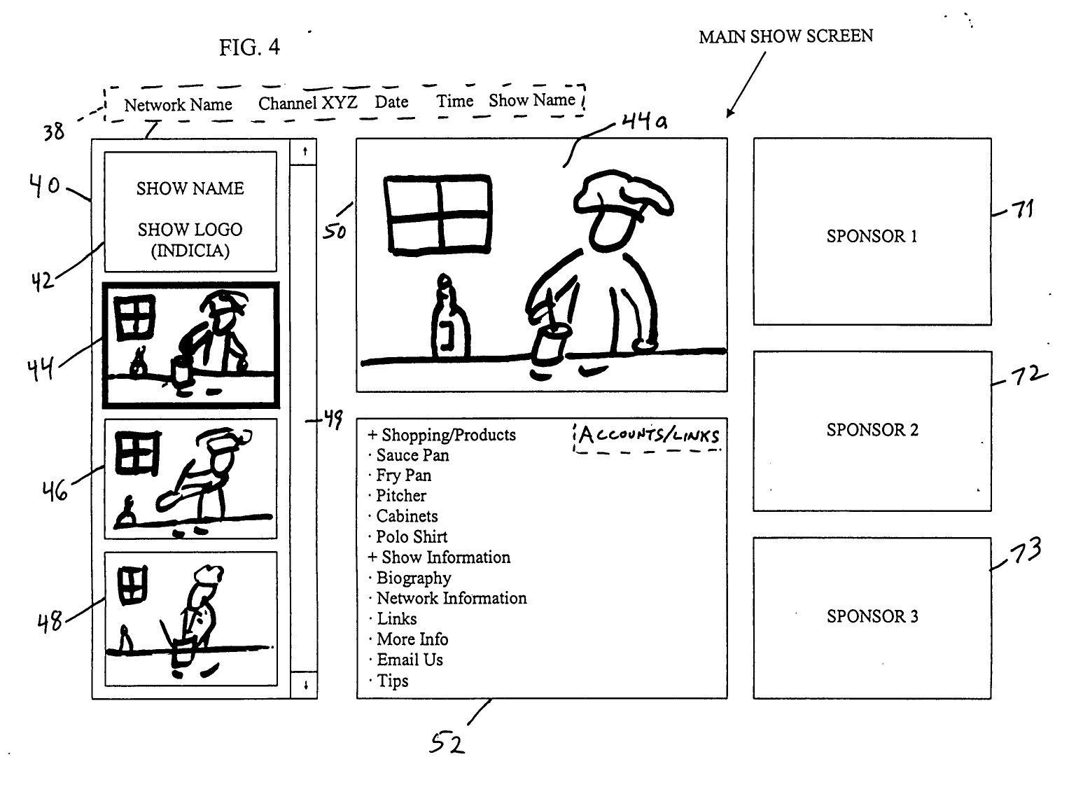

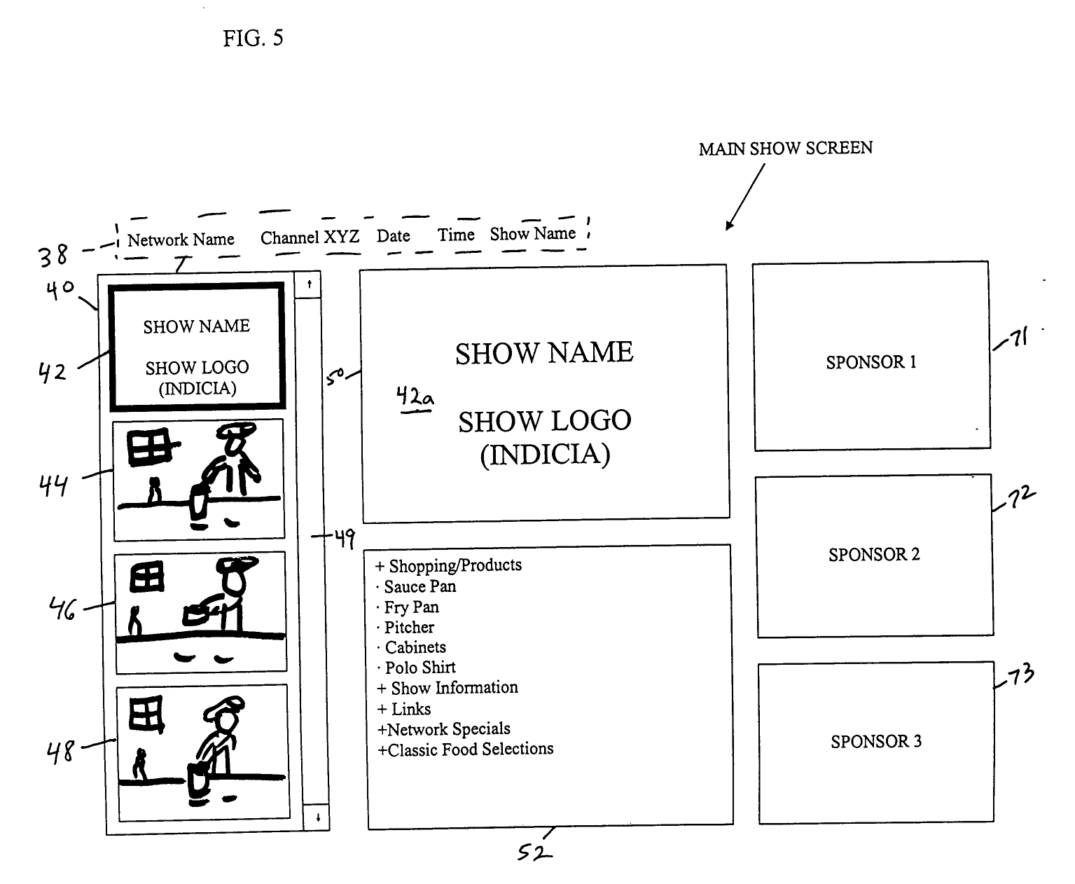

Some preferred displays are shown in FIGS. 4 to 7.

With reference also to the flow chart of FIG. 11, when the Banked Frames screen is entered (step 101), preferably at the top-line (or other prominent place) there is a synopsis 38 of the show information for this show and its banked frames (step 102). This information is similar to a line in the show list screen, preferably containing (at least) Show Title, Date/Time/Channel Recorded, Duration, Status and Title.

If there are Banked Frames for this show, there is preferably a column 40 (shown on the left in FIG. 4) of thumbnails 42, 44, 46 and 48, first thumbnail 42 preferably containing the show name an indicia such as a show logo, and the remaining thumbnails 44, 46, 48, etc. corresponding to each banked frame (step 103). Scrolling (at scroll bar 49) down this list selects a frame and an enlarged version (44a in FIG. 4) of the currently highlighted (selected) frame (frame 44 in FIG. 4) is preferably displayed, e.g., in a central Banked Frame box 50 (step 104). Any associated links with such selected frame and the associated “accounts” are populated into the List of accounts for linking, preferably located below the (enlarged) thumbnail, as shown by box 52 in FIG. 4 (steps 105 and 106). The links are accessed by having been stored with the show data or separately obtained. E.g., when the Banked Frame screen (recall frame) mode is entered, data stored with the show or default data could specify where to locate the links, e.g. by communicating with the backend, or other provider, or other specified default location.

Even if there are no banked frames for the show, preferably there is always at least one thumbnail in the list. This is preferably initial thumbnail 42, a master frame, e.g., which may be predetermined by the program producer or if there is no data identifying the master frame, then the system may display the first non-black frame of the show (which has been stored on the disk or hard drive).

If there are banked frames or predetermined frames identified by the producer for this program (stored on the hard drive or disk), then, when this frame is selected, all links (and accounts-categories of links) for the show are populated into the Account and Links window 52 (steps 106, 107). Sponsor links may also be displayed (step 108). To select an account or link from the list, the viewer can use the RIGHT button to go to the list from the thumbnail box, then scroll up or down the list with the UP and DOWN keys.

In the most preferred embodiment of the invention, multiple links are associated with each frame, and more particularly with various objects or sections of the frame (the links may be embedded by the system taught in U.S. patent application Ser. No. 10/443,301, or by any other system. It is also possible to embed just one link in a frame. In addition, one or more links may be associated with a frame but not a specific object or section. Links may also be associated with each frame in a scene, and/or the entire program. Links may even be associated with all programming or some programming provided by a particular producer and/or network, and/or cable, satellite or other back-end provider. Any combination of one or more links of each type may be provided.

Scrolling down the thumbnails column selects each thumbnail in turn. Pressing the PLAY button at this point jumps the (on disk) program back to the location of the banked frame and it will play from there, automatically, or if desired, by pressing PLAY again. Thus, step 111, switching to play mode could be done at anytime. This functionality requires no metadata be stored or available for the program's clicks (banked frames, e.g., by pressing the CLICK button 20j on remote 21. Where there is no linking data associated with a banked frame, the CLICK button serves as bookmarking a frame of interest. Optionally, the display format can be rearranged, such as by selecting a button, e.g., the right arrow, which moves thumbnails from the Thumbnail column 40 to the link's window 52.

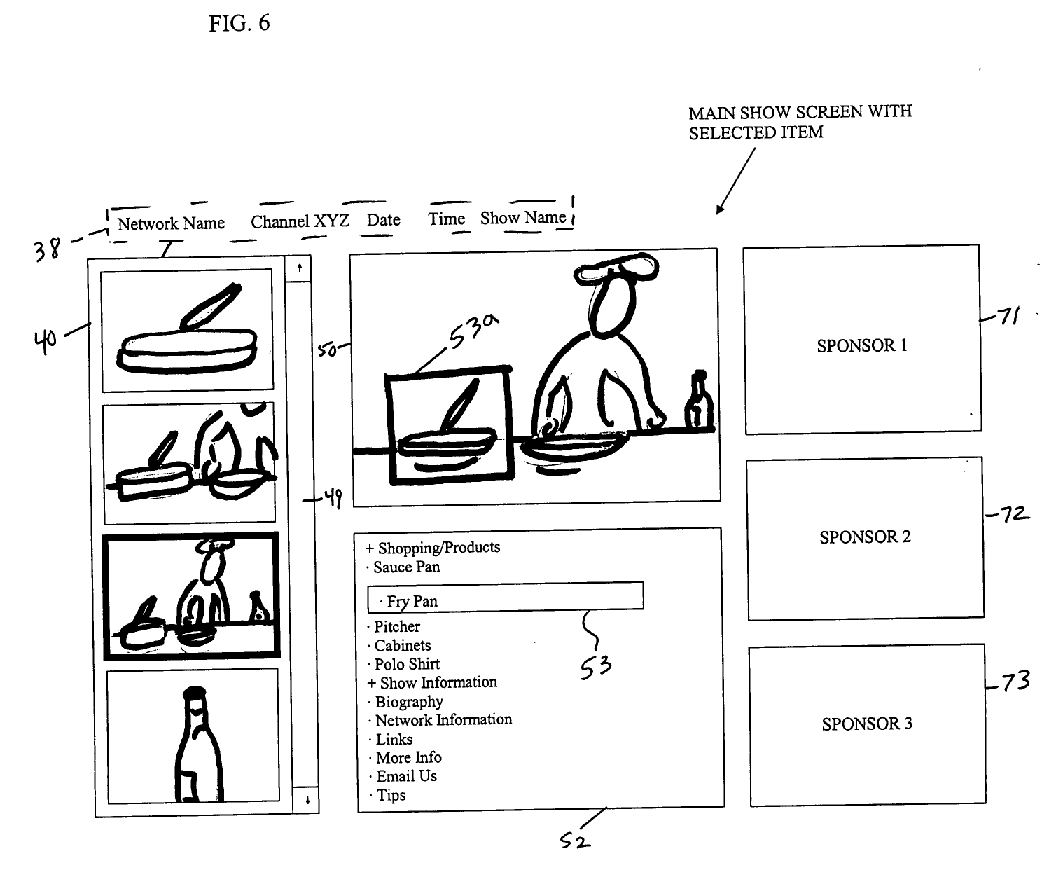

Selecting an account from the list, the viewer can “expand” (select) or collapse (select-again) the account to show all the links that have been sorted into that account for the selected frame. Then, for example, scrolling up or down will selectively highlight a link, e.g., link 53 in FIG. 6. Pressing SELECT OR RIGHT with this link highlighted will launch data or information to which the link points (step 110).

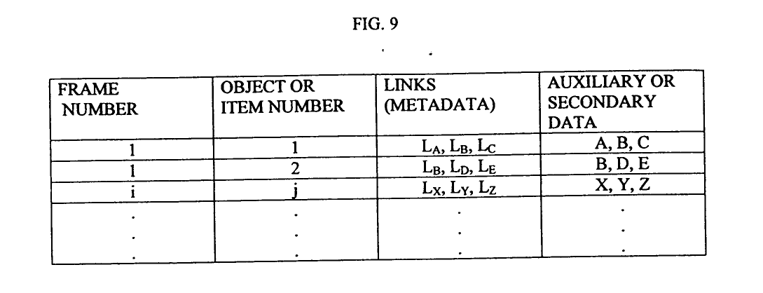

That is, the video signals corresponding to the program, show, movie, or whatever video is being viewed from whatever source is selected, are preferably previously associated with link's referred to herein also as metadata to link the show itself, frame, or portions of the frame (referred to as “primary data”), to additional information, advertisements, additional video, or any other supplemental information, referred to as “secondary data.” Such linking is shown schematically in the table of FIG. 9. There, for frame i, object or item j in the frame has three links, Lx, Ly and Lz associated with it, these links pointing to secondary data X,Y and Z, respectively. There can be multiple objects in a frame or no objects.

The links or metadata may be stored in association with the shows video data, or it may be stored or sent to or obtained by the box 8 separately. The same is true of the secondary data. Further, the secondary data can be stored or sent to or obtained by the box 8 separately from the linking data, or together with it.

For example, a link may point to another program or video, which can be launched into the full-screen TV or it can be launched into the banked frame window 50 located above the links/accounts list 52 (step 112).

Scrolling up or down the links highlights the link as a form of visual feedback. Another feedback mechanism is as each link is highlighted; a box/rectangle is drawn around the item in the banked frame (above the link window) if the link corresponds to an item or object in the frame, so that the viewer can see what in the frame is the basis for the link (step 109). Some links for a frame may be localized to a specific location on the image (such as the fry pan 53a in FIG. 6, or they may be more global in that the link is associated with the whole frame, or a whole scene containing the frame, or the entire program. In the case of such a global link, just highlighting the link name in window or box 52 is preferable.

If the link specifies a web page, then a window (full-screen) can open up or the HTML/XML can be rendered into, e.g., the banked frame window 50 without creating a new full page, although a new page (screen) may be opened. The web link may be direct to the set top box 8 from interne 18 or it may be via a viewer's networked PC 11, or other device such as a pocket PC. Metadata and secondary data may also come from any of the sources shown in FIG. 8, and/or any address specifiable by URL or more broadly by URI.

Also, it is preferable to provide a display of advertisements and/or sponsor or other information, which is shown in a column on the right (or other desired format) in FIGS. 4 to 7, shown as Sponsors 1 through 6, respectively labeled 71 through 76 (step 113, which can occur at any time). Using the RIGHT button or other appropriate button, or links which can be listed in window 52, the cursor or indicator can move to the right from the Account/Link window 52 to a selected Sponsor icon, logo or advertisement. Selecting one of these logos and pressing enter launches the link (associated with the logo) in the specified way on the specified window (step 114).

It is worth noting here, that if the link launched video, then this video is also a (virtual) program and as such, all of the same functions discussed above may be applied to this new video stream, which would be stored in the memory for set top box 8 and so the user can record the video stream and can bank selected frames.

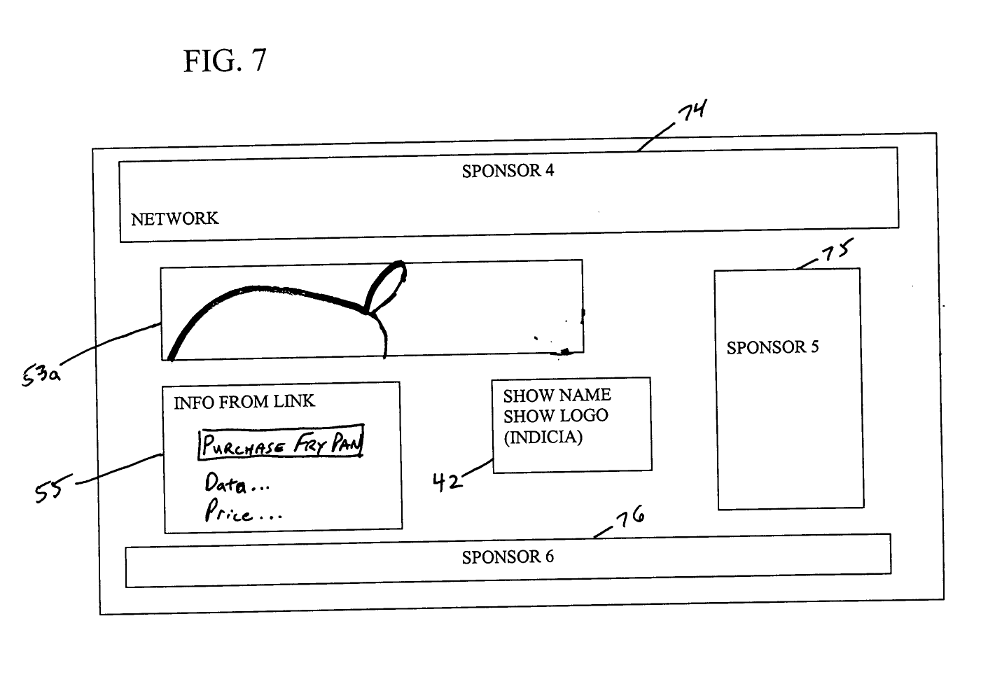

In accordance with another aspect of the invention, the third party system 23 (FIG. 8) may be a remote vendor or database, or a merchant's database of client accounts, and the links in window 52 may contain, and/or the sponsors 1 to 6 (elements 71 to 76, respectively) may contain an opportunity for interaction such as to obtain a coupon. The viewer selects the sponsor link or sponsor icon, which may launch a window where the user enters his or her identification number for that sponsor/merchant, and/or his or her address information, or unique information known to the video back end provider, so that the user's address can be determined and a coupon can be mailed to the user (steps 122, 124 and 125). Preferably, the coupon would be electronically stored in the merchant's database through the use of an existing identification number, a number assigned at the time of this electronic coupon selection, and/or other identification technique. Accordingly, the user need only tender his or her unique account identification number or mechanism, such as home phone number or club card, and the merchant's database has stored therein the coupon (and its expiration date, if there is one). For example, the coupon could be for a supermarket item, and when the user enters into the transaction purchasing the item that the coupon is for, and providing his or her supermarket account identifier (club card, home phone, etc.), the coupon is automatically applied (steps 125 and 126). This electronic coupon process could also be used, for example, for an electronic coupon for purchasing by mail, on-line, and/or other methods (step 127). The merchant, vendor or other third party could also generate an email to the viewer at the time of the viewer's selection of the advertisement/sponsor icon, and/or later (step 126). If the user is not connected to the internet directly, a connection could be made through the back end video provider, or by modem associated with the set top box. The box's CPU could be set to dial out and contact the video provider, and/or third parties, directly or through the internet, at specified intervals after the viewer has made sponsor, coupon, or other interactive selections. The sponsor link or advertisement can also be a call or opportunity to purchase, in real time or time deferred. An opportunity to purchase or obtain a coupon or request an email or other interaction can arise from clicking on a link in window 52, e.g., the fry pan 53, which can then be shown enlarged as shown at 53a in FIG. 7. In addition, FIG. 7 shows a window, e.g., below the enlarged pan with a buy button, and information about the pan, its price, etc.

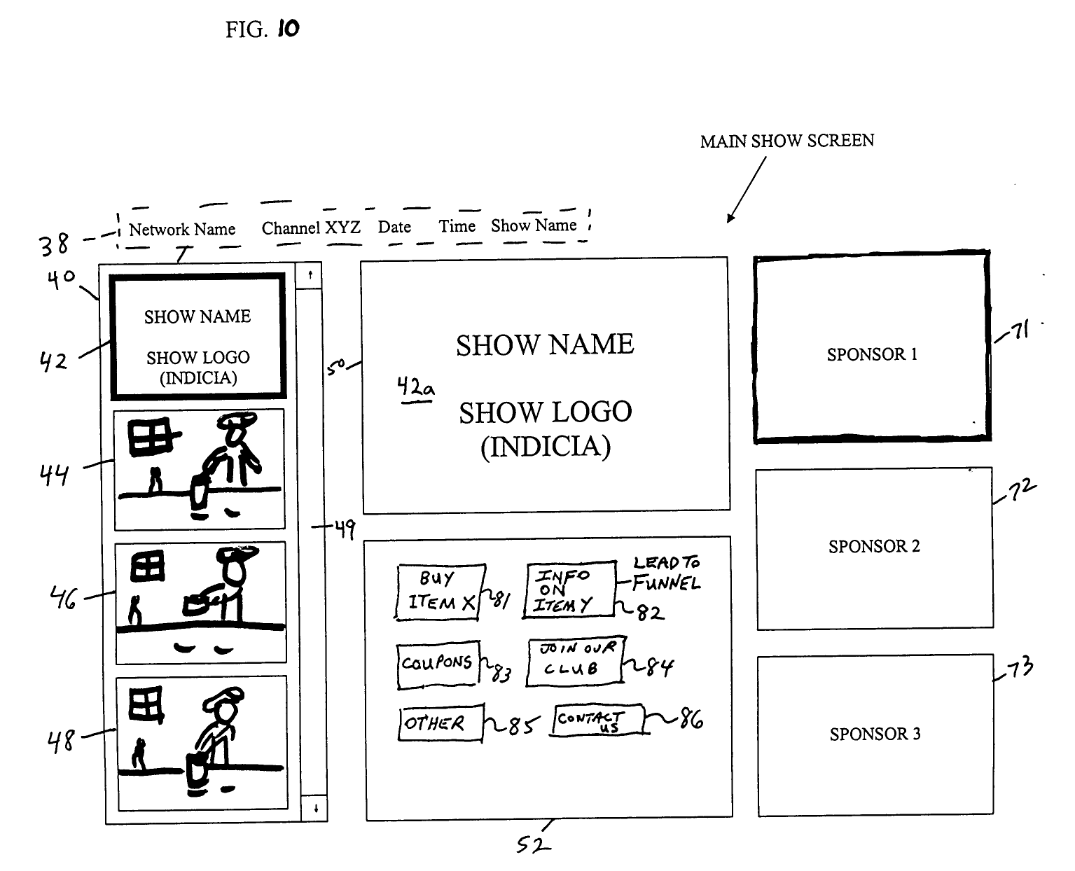

The highlighting of a sponsor link, e.g., sponsor link 1 (element 71) as shown in FIG. 10, can populate the window 52 with various links as noted above, e.g., a buy item X link 81, an information on item Y link 82 (e.g., which may lead to a funnel), a coupon or coupons link 83, a sign up (opt in) link 84, other links 85 and/or a contact us link 86 (e.g., for email information or other purpose).

Another aspect of the invention enables the user to select a sponsor logo or icon, or other link, which then provides a relatively short text, video, audio or multimedia segment, and gives the user the opportunity to go to a further segment of longer length, which in turn may lead to even further information. This is commonly referred to as a funnel, and thus the invention in a preferred embodiment provides a link to an information funnel or telescope. Moreover, all programming, even commercials, station identification, and any other programming can have embedded or associated links.

It is also possible, by the above electronic transactions for merchants or others to track user specific data, and the success or nonsuccess of various advertising (step 128), with appropriate privacy controls as required by any applicable laws.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. A method of banking or storing video frames and their associated links, the method comprising the steps of:
a) associating multiple links with a video frame in a series of video frames, each of the links having information associated therewith;
b) selecting and banking the video frame from among the series of video frames; and
c) selecting and displaying the frame in connection with representations of the links.

2. The method of claim 1, further comprising a step of selecting one of the links and displaying the information associated therewith.

3. The method of claim 2, wherein in the step of selecting and displaying one of the links, the information associated therewith is displayed.

4. The method of claim 1, further comprising a step of displaying the information in the form of an advertisement.

5. The method of claim 4, further comprising a step of selecting the advertisement, and subsequently receiving credit for such selection in a viewer's account with a merchant.

6. The method of claim 4, further comprising a step of selecting the advertisement, and subsequently receiving credit for such selection in a viewer's account with a merchant in the form of an electronic coupon.

7. The method of claim 1, further comprising a step of displaying the information in the form of a first item of information, wherein selecting the first item of information provides a first level of detail of information and a display to select a second item of information providing a second level of detail of information greater than the first level.

8. The method of claim 7, further comprising a step of providing a display for a third item of information providing a third level of detail of information greater than the second level.

9. The method of claim 1, further comprising a step of displaying the information in the form of an opportunity to purchase at least one of goods and services

10. The method of claim 1, further comprising a step of storing a record of data relating to the viewer's selections of frames and of the viewer's selections from the stored frames, and transmitting the data to a source remote from the viewer.

11. The method of claim 1, further comprising a step of selecting one of the links and displaying the information associated therewith, and a step of transmitting data in response to the selection to at least one of a PDA, email address, cellular telephone and a pocket PC.

12. The method of claim 1, further comprising a step of selecting one of the links and displaying the information associated therewith, and a step of transmitting data in response to the selection to a remote location.

13. The method of claim 1, further comprising a step of displaying a thumbnail image of multiple selected and stored frames in conjunction with displaying a selected one of the thumbnail images as a larger image than the thumbnail images at the same time, and also displaying at least one advertisement at the same time.

14. An apparatus for banking video frames associated with links, comprising:
a monitor for displaying video images from a series of video frames;
a memory for storing the video images, and containing multiple links associated with a video frame in a series of video frames, each of the links having information associated therewith;
a processor responsive to selection of a desired one or more of the video frames from among the series of video frames, and responsive to selecting a stored series of video frames and displaying at least one selected frame in connection with linking data for linking at least one of the selected frame and objects in the selected frame with additional data.

15. The apparatus of claim 14, wherein the monitor is for displaying television video, and for displaying the links in conjunction with the associated frame.

16. The apparatus of claim 15, wherein the controller is adapted for displaying the information associated with the links on the monitor at the same as the links.

17. The apparatus of claim 16, wherein the monitor is adapted for displaying the information in the form of at least one advertisement.

18. The apparatus of claim 17, wherein in response to selection of the advertisement, the apparatus sends a signal selecting a credit for such selection in a viewer's account with a merchant.

19. The apparatus of claim 17, wherein in response to selecting the advertisement, and subsequently receiving credit for such selection in a viewer's account with a merchant in the form of an electronic coupon.

20. The apparatus of claim 17, further comprising links comprising at least one of a lead in to a funnel, telescope, an opt in for a coupon, a purchase of a displayed item.

21. The apparatus of claim 14, further comprising means for storing a record of data relating to the user's selections of frames and the user's selections from the stored frames, and for transmitting the data to a source remote from the viewer.

22. The apparatus of claim 14, further comprising means transmitting data in response to the selection to at least one of a PDA, email address, cellular telephone and a pocket PC.

23. The apparatus of claim 14, further comprising means for transmitting data in response to the selection to a remote location.

24. The apparatus of claim 1, further comprising a display which displays a thumbnail image of multiple selected and stored frames in conjunction with displaying a selected one of the thumbnail images as a larger image than the thumbnail images at the same time, and also displaying at least one advertisement at the same time.
